(19) United States
(12) Patent Application Publication
(10) Pub. No.: US 2008/0119955 A1
(43) Pub. Date: May 22, 2008

(54) Information confirmation system

(75) Inventors: Robert E. Blake, Woodbury Heights, NJ (US); Robert W. Perry, Sicklerville, NJ (US); Steven D. Essinger, Philadelphia, PA (US)

Correspondence Address: Glenn A. Cavanaugh;METROLOGIC INSTRUMENTS, INC, 90 COLES ROAD, BLACKWOOD, NJ, 08012, US

(73) Assignee: Metrologic Instruments, Inc.

(21) Appl. No.: 11/602,453

(22) Filed: Nov. 20, 2006

(51) Int. Cl. G06F 19/00

(52) U.S. Cl. 700/115

(57) ABSTRACT

A method for confirming information using multiple information gathering subsystems is provided. In one embodiment, the method attempts to gather primary information using a first information gathering subsystem. The method also attempts to gather secondary information using a second information gathering subsystem. Thereafter, the method compares the primary information when gathered by the first information gathering subsystem with the secondary information when gathered by the secondary information gathering subsystem. In various embodiments, information gathered from one information gathering subsystem can be used to derive information not retrieved (due to a failed gathering attempt) from the other information gathering subsystem. In still other embodiments, a third information gathering subsystem can be used to gather tertiary information. The tertiary information can be used when needed to confirm or derive primary or secondary information. In yet other embodiments, a computer-readable medium, an apparatus, a processor, and system are also provided which perform similar features recited by the above method.

### BACKGROUND OF THE INVENTION

1. Field of the Invention

These and other deficiencies of the prior art are addressed by the present invention which generally relates to tracking systems and more particularly, to a method, a computer-readable medium, an apparatus, a processor, and systems for confirming item information using independent information gathering subsystems.

2. Description of the Related Art

Items are bought, sold, and transported throughout the world. To track these items, tracking systems are used which utilize tracking systems based upon, for example, optical code scanning technologies, radio frequency identification (“RFID”) technologies, and imaging technologies. For example, point-of-sale (“P.O.S.”) stations in retail stores and supermarkets, in inventory management (e.g., document tracking), and in diverse data control applications.

Optical scanners have been used to read and interpret various types of optical code symbols. Optical code is typically located on item labeling. Because of the ease in which optical code can be placed on items, optical code can be used in many environments. Optical code contains detailed information regarding the characteristics of objects (e.g., the date of manufacture, inventory status, destination, and owner).

Many optical scanning systems, or scanners, generate a beam of light that reflects off optical code symbols so that the scanning system can receive the reflected light. The system then transforms that reflected light into electrical signals, and decodes those electrical signals to extract the information embedded in the optical code symbols. Imaging based scanning systems are often used to scan 2-dimensional code or to capture the image of an item (e.g., a package).

While inexpensive and effective, the optical code system has certain limitations. For example, bar codes must be visible, which limits the locations in which they may be placed, and bar codes can easily be obscured, either accidentally or intentionally. Because optical codes are often exposed to permit detection, the optical code is susceptible to damage that can result in detection failures. For example, the label on which the optical code resides may be torn, worn, or at least partially obscured. Because optical code is susceptible to wear and tear; and requires proper orientation with respect to the optical scanner, there are occasions when valuable information contained within the optical code is not retrievable.

An RFID system typically employs at least two components, a “transponder” (also known as a “tag”) which is attached to the physical item to be identified, and a “reader,” which sends an electromagnetic signal to the transponder and then detects a response. Typically, the reader emits an RF signal, which is received by the transponder, after the transponder comes within an appropriate range. In response, the transponder then sends its information via a modulated RF signal back to the reader. The reader detects this modulated signal, and can identify the transponder by decoding the modulated signal. After identifying the transponder, the reader can either store the decoded information or transmit the decoded signal to a computer.

Often a user may want to have at least one other subsystem for gathering information about an item when the first information gathering subsystem failed to gather information (e.g., due to improper orientation of the item with respect to the information gathering system, or damage to an article which stores the information (e.g., faded or impaired optical code); and/or confirm the information regarding the item (e.g., for security). Therefore, there is a great need in the art for an improved mechanism which avoids the shortcomings and drawbacks of prior art tracking/inventory apparatuses and methodologies.

### SUMMARY

These and other deficiencies of the prior art are addressed by the present invention which generally relates to tracking systems and more particularly, to a method, a computer-readable medium, an apparatus, a processor, and systems for confirming item information using independent information gathering subsystems. In one embodiment, the method attempts to gather primary information using a first information gathering subsystem. The method also attempts to gather secondary information using a second information gathering subsystem and tertiary information using a third information gathering subsystem. Thereafter, the method compares the primary information when gathered by the first information gathering subsystem with the secondary information when gathered by the second information gathering subsystem (and tertiary information when gathered by the third information gathering subsystem).

In various embodiments, information gathered from one information gathering subsystem can be used to received information not retrieved (due to a failed gathering attempt) from the other information gathering subsystem. For example, in one embodiment, the method attempts to scan optical code on an item and interrogates a radio frequency identification (“RFID”) transponder on the item, when the attempt fails. Thereafter, the method uses the information obtained from the transponder to determine the information in the optical code.

In yet other embodiments, a computer-readable medium, an apparatus, and system are also provided which perform similar features recited by the above method. Illustratively, the information gathering subsystems are described as an optical code scanning subsystem, a radio frequency identification (“RFID”) subsystem, and an imaging subsystem (e.g., a camera subsystem). However it is appreciated that other types of information gathering subsystems can be used in accordance with the invention.

In yet other embodiments, a computer-readable medium, an apparatus, a processor, and systems are also provided which perform similar features recited by the above method. In each of the embodiments, the optical code can be bar code and/or an optional feature can be the writing of information by the reader to the transponder.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only aspects of this disclosure and are therefore not to be considered limiting of its scope, for the invention may admit to other equally effective embodiments.

FIG. 1 is a perspective view of an illustrative information confirmation system used in accordance with aspects of this disclosure;

FIG. 2 is a high level block diagram of an exemplary system for performing aspects of this disclosure;

FIG. 3 is a close up view an exemplary transponder/reader pair used in accordance with aspects of this disclosure;

FIG. 4 depicts a flow diagram of an illustrative method used in accordance with aspects of this disclosure;

FIG. 5 depicts another flow diagram of an illustrative method used in accordance with aspects of this disclosure; and

FIG. 6 depicts a high level block diagram of a computer architecture for performing aspects of this disclosure.

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

For illustrative purposes only, the invention is described as using several information gathering subsystems (e.g., an optical scanning system, a radio frequency identification (“RFID”) subsystem, a weighing subsystem, and an imaging subsystem (e.g., a camera system)). However this description is not intended in any way to limit the scope of the invention. It is appreciated that other types of information gathering subsystems can be used in accordance with this disclosure. An “information gathering subsystem” as used herein is any subsystem which receives information regarding an item(s) that enters within the information gathering range of the information gathering subsystem.

It is appreciated that the invention is not limited to the types of optical scanners disclosed herein. This document incorporates by reference all of the material disclosed within commonly owned and assigned U.S. Pat. No. 5,796,091 issued Aug. 18, 1998 and entitled AUTOMATIC HAND-SUPPORTABLE OMNIDIRECTIONAL LASER PROJECTION SCANNER WITH HANDLE-CONTROLLABLE PROJECTION AXIS; commonly owned and assigned U.S. Pat. No. 5,808,285 issued Sep. 15, 1998 and entitled PORTABLE CODE SYMBOL READING DEVICE WITH ONE-WAY WIRELESS DATA PACKET TRANSMISSION LINK TO BASE UNIT EMPLOYING CONDITION-DEPENDENT ACOUSTICAL SIGNALLING FOR DATA PACKET RECEPTION ACKNOWLEDGEMENT; commonly owned and assigned U.S. patent application Ser. No. 11/203,669 published Feb. 23, 2006 and entitled POINT OF SALE (POS) BASED BAR CODE READING AND CASH REGISTER SYSTEMS WITH INTEGRATED INTERNET-ENABLED CUSTOMER-KIOSK TERMINALS; commonly owned and assigned U.S. Pat. No. 6,554,189 (referred to hereinafter as “the '189 patent”) issued Apr. 29, 2003 and entitled AUTOMATED SYSTEM AND METHOD FOR IDENTIFYING AND MEASURING PACKAGES TRANSPORTED THROUGH A LASER SCANNING TUNNEL, as if being set forth in its entirety herein.

As will be appreciated by one having ordinary skill in the art, virtually all conventional RFID transponders (e.g., passive or active tags 2.45 GHz, 125 KHz, 13.5 MHz, 900 MHz) can be employed within the scope of the present invention. Such transponders are described in numerous references. It is appreciated that the invention is not limited to the types of RFID systems disclosed herein.

Various imaging systems can be used in accordance with this disclosure. For example, this disclosure incorporates by reference all of the material disclosed in commonly owned and assigned U.S. patent application Ser. No. 20060086794 published Apr. 27, 2006 and entitled X-RADIATION SCANNING SYSTEM HAVING AN AUTOMATIC OBJECT IDENTIFICATION AND ATTRIBUTE INFORMATION ACQUISITION AND LINKING MECHANISM INTEGRATED THEREIN; and commonly owned and assigned U.S. patent application Ser. No. 20050116041 published Jun. 2, 2005 and entitled HAND-SUPPORTABLE IMAGING-BASED BAR CODE SYMBOL READER EMPLOYING AN AUTOMATIC LIGHT EXPOSURE MEASUREMENT AND ILLUMINATION CONTROL SUBSYSTEM WHICH CONTROLS LED ILLUMINATION DRIVER CIRCUITRY TO EXPOSE AN AUTOMATICALLY DETECTED OBJECT TO A FIELD OF NARROW-BAND LED-BASED ILLUMINATION ONLY WHEN SUBSTANTIALLY ALL ROWS OF PIXELS IN A CMOS IMAGE SENSING ARRAY ARE IN A STATE OF INTEGRATION, THEREBY CAPTURING HIGH QUALITY DIGITAL IMAGES INDEPENDENT OF THE RELATIVE MOTION BETWEEN SAID BAR CODE SYMBOL READER AND THE OBJECT, as if being set forth in its entirety herein.

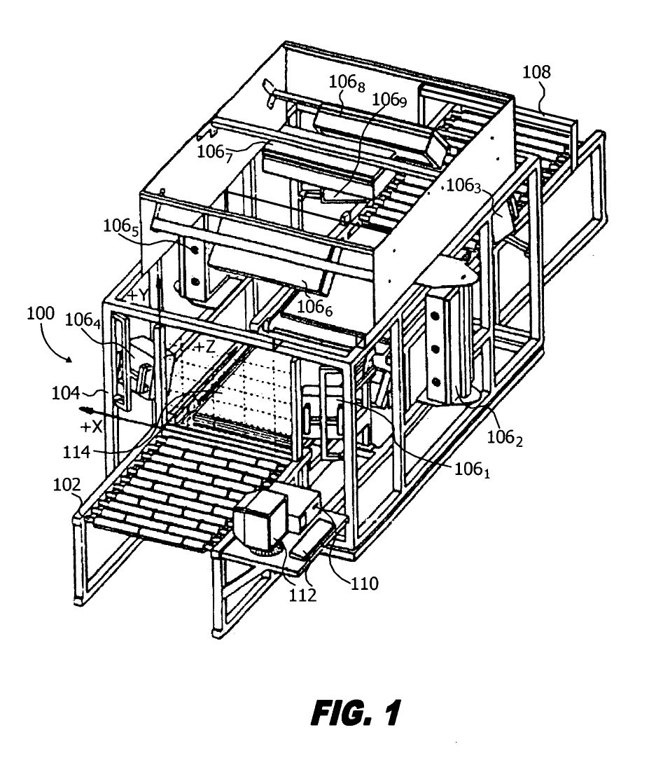

FIG. 1 is a perspective view of an illustrative tracking system 100 used in accordance with aspects of this disclosure. The system 100 includes a conveyor 102; an overhead support structure 104; optical scanners 1061, 1062, 1063, 1064, 1065, 1066, 1067, 1068, and 1069 (collectively scanners 106); an RFID antennae 108, a computer 110; and a user interface 112 (e.g., a keyboard and monitor). For convenience, FIG. 1 also includes an “X,” “Y,” and “Z” axis. In addition, the tracking system 100 optionally includes a weighing subsystem (e.g., a scale) (not shown).

As an item (not shown) moves along the conveyor 102 (i.e., parallel to the “Z” axis), the item eventually enters the scanning zone 114. Illustratively, the scanning zone 114 is depicted as the cavity formed by the overhead support structure 104 and conveyor 102. However that depiction is not intended in any way to limit the scope of the invention. For example, in various embodiments, the scanning zone 114 can also incorporate an area outside of the cavity formed between the conveyor 102 and the overhead support structure 104 (e.g., by incorporating scanners under the conveyor 102). The scanners 106 attempt to scan optical code located on the item. For example, optical scanning can occur in a manner similar to that described in the '189 patent. If the optical scan is successful, information from the scan is transmitted towards the computer 110. A user may then view and further process the information using the user interface 112.

Information gathered from a first information gathering subsystem (e.g., the optical scanning system) is referred to herein as primary information. Information gathered from a second information gathering subsystem (e.g., the RFID subsystem) is referred to herein as secondary information. Information gathered from a third information gathering subsystem (e.g., the weighing subsystem) is referred to herein as tertiary information. The references to primary information, secondary information, and tertiary information are only used to indicate that one set of information is gathered from one information gathering subsystem, a second set of information is gathered from a different information gathering subsystem, and a third set of information is gathered from an information gathering subsystem different from the information gathering subsystems which gather the first set of information and the second set of information.

If, however, the optical scan is unsuccessful the computer 10 gathers information (via a reader antenna 108) from an RFID transponder located on the item. Prior to the reader receiving information from the transponder (information used to derive the information in the optical code) the reader transmits an interrogation signal. The interrogation signal can be transmitted during the optical scanning attempt or after an indication that the scanning attempt has failed.

Although FIG. 1 depicts the scanning system 100 as having a single antenna 108 positioned after the scanning zone 114 it is appreciated that the antenna can be positioned in the scanning zone 114 and that multiple antennas can be used. In addition, it is also appreciated that the subject matter of this disclosure can be incorporated into handheld (i.e., portable) scanning devices.

Although FIG. 1 is depicted and described using an optical scanning subsystem and an RFID subsystem that depiction and description is for illustrative purposes only. It is appreciated that various combinations utilizing an imaging system, the weighing subsystem, and the RFID system can be used in accordance with this disclosure.

In other embodiments, the second information gathering subsystem attempts to gather information regardless of the success of the attempt to gather information from the first information gathering subsystem.

In yet other embodiments, a third information gathering subsystem can be used to gather tertiary information. For example, the third information gathering subsystem can be the weighing subsystem. When attempts are made to gather information using the first information gathering subsystem and/or second information gathering subsystems (or there is a failure of either/both of these information gathering subsystems fail, the third weighing subsystem can be used to confirm and/or identify the item; or assist in deriving the information that should have been gathered by either/both the first and second information gathering subsystems.

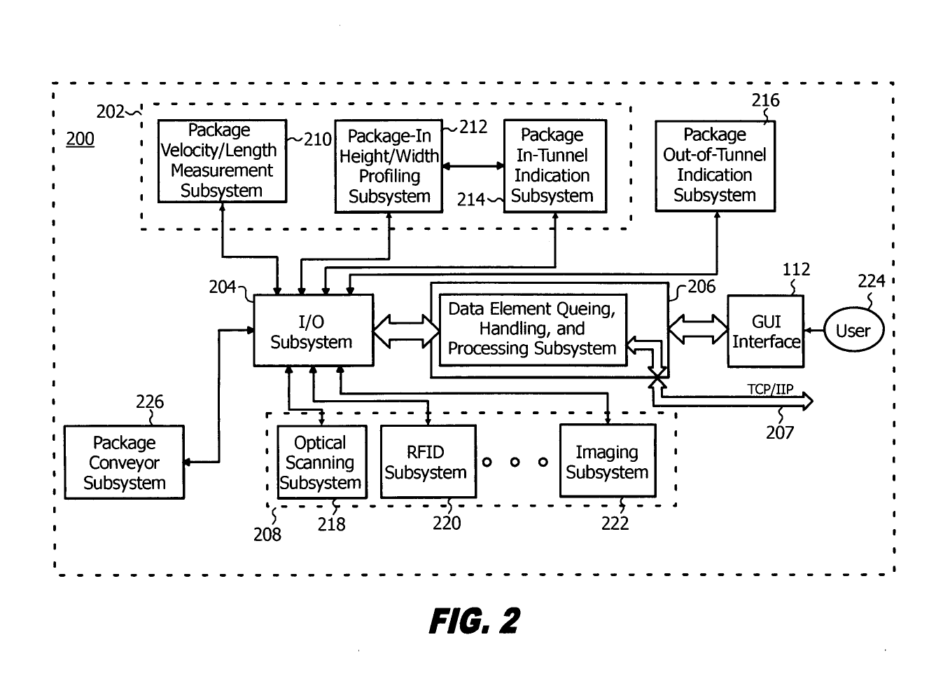

FIG. 2 is a high level block diagram of an exemplary system 200 for performing aspects of this disclosure. The system 200 includes an item movement subsystem 202, a package out-of-tunnel indication subsystem 216, an I/O subsystem 204, a general information gathering subsystem 208, a package conveyor subsystem 226, a data element queuing, handling, and processing subsystem 206, a graphical user interface (“GUI”) subsystem 112, and a user 224 (optional).

The I/O subsystem 204 controls the other subsystems. The user 224 is able to view the status of the subsystem and to enter instructions via the GUI 112. Communication between the I/O subsystem and the GUI 112 is provided by the data element queuing, handling, and processing subsystem 206. In addition, a TCP/IP interface is optionally coupled to the data element queuing, handling, and processing subsystem 206 for communication over a network.

The item movement subsystem 202 includes a package velocity/length measurement subsystem 210, a package height/width profiling subsystem 212, and a package in-tunnel indication subsystem 214. When an item is placed on the moving conveyor 102 the package velocity/length measurement subsystem 210 measures the velocity and length of the item on the conveyor 102; the package height/width profiling subsystem 212 measures the height and width of the item; and the package in-tunnel indication subsystem 214 provides information regarding whether the item is in the tunnel. When the item has passed through and outside the tunnel the package out-of-tunnel subsystem 216 transmits information towards the I/O subsystem 204.

The I/O subsystem 204 transmits information from the item movement subsystem 202 to the data element queuing handling, and processing subsystem 206 for processing and, when necessary receives information from the data element queuing handling subsystem 206 for transmission towards the general information gathering subsystem 208.

The information gathering subsystem 208 illustratively depicted as including an optical scanning subsystem 218, an RFID subsystem 220, and an imaging subsystem 222. Although not depicted, it is appreciated that the general information gathering subsystem 208 can include other types of subsystems (e.g., a weighing subsystem). It is further appreciated that the general information gathering subsystem 208 includes at least two different types of information gathering subsystems.

In further embodiments, the imaging subsystem 222 is a camera subsystem (e.g., a plurality of cameras strategically positioned around the conveyor 102 to capture images from the desired perspective).

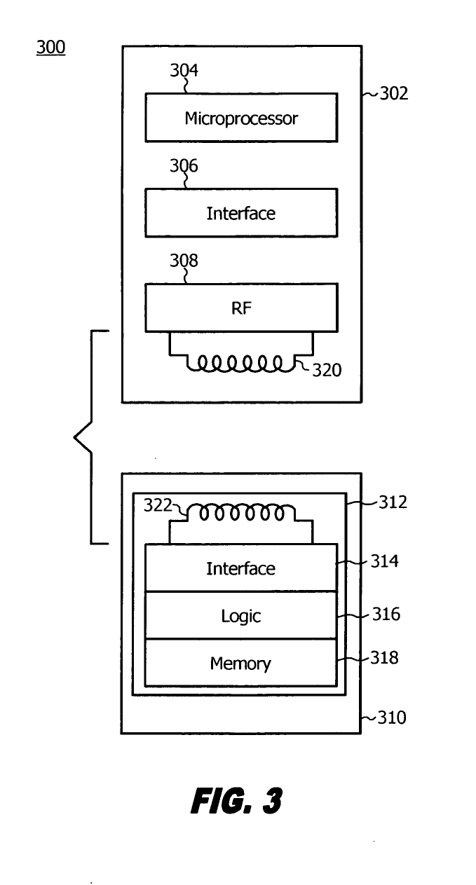

FIG. 3 shows a general example of a reader/transponder pair 300 used in accordance with this disclosure. Illustratively, the reader/transponder pair 300 is described using a passive transponder 310. However, it is appreciated that other types of transponders may be used in accordance with this disclosure. The reader/transponder pair includes a reader 302 and the transponder 310.

The reader includes a housing 302, a microprocessor 304, a radio frequency (“RF”) modulator 308 having an antenna 320, and an interface 306 to communicate information between the microprocessor 304 and the RF modulator 308.

The transponder 310 includes a housing 312 having therein an antenna 322 coupled to an interface 314, logic 316, and memory 318. When the reader 302 transmits an interrogation signal, via antenna 320, the transponder antenna 322 receives the interrogation signal. The coil antenna 322 and interface 314 includes a passive resonant radio RF circuit (not shown) for use in detecting when the transponder 310 is within a zone monitored by the reader 302 and for providing power to the transponder 310. Furthermore, the transponder 310 provides “intelligence” to the transponder 310 via logic circuits 316. Memory 318 is coupled to the logic circuits 316. When prompted the logic circuits gathers information from memory 318 and returns a signal containing a packet of preprogrammed information. The packet of information (data pulses) is received and processed by reader 302 receiving circuitry and is decoded (if necessary) to provide identification information about the item upon which the transponder 310 is attached.

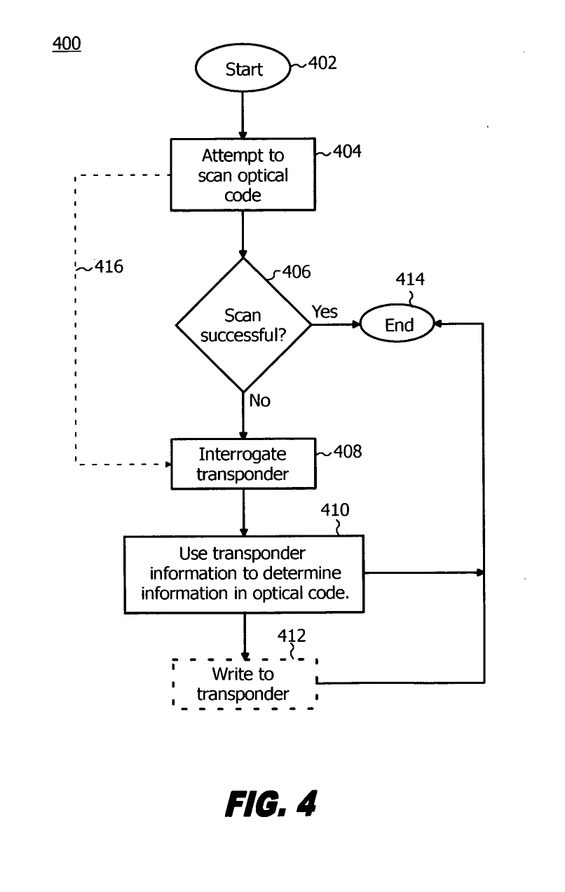

FIG. 4 depicts a flow diagram of an illustrative method 400 used in accordance with aspects of this disclosure. For brevity, the information gathering subsystems are described as using an optical scanning subsystem and an RFID subsystem. However, that description is not intended in any way to limit the scope of the invention. It is appreciated that the method 400 can incorporate other information gathering subsystems (e.g., a weighing subsystem and/or an imaging subsystem). The method 400 begins at step 402 and proceeds to step 404.

At step 404, the method 400 the first information gathering subsystem attempts to gather information (e.g., an optical scanning subsystem attempts to scan optical code). In various embodiments, the scan attempt is performed while an item is on a conveyor 102 and in other embodiments, the scan attempt is performed by a portable (i.e., handheld scanner). The method 400 queries, at step 406, whether the attempt to gather information was successful. If the scan attempt is successful (i.e., optical code was successfully scanned and interpreted), information gathered from the optical scan is stored in memory. Thereafter, the method 400 in one embodiment proceeds to and ends at step 314.

If, however, a negative determination is made at step 406, the method 400 proceeds to step 408. At step 408, the second information gathering subsystem attempts to gather information (e.g., an RFID subsystem). At step 408, the reader 302 receives an instruction to initiate transmission of an RFID interrogation signal to transponder 310. Depending on the type of RFID system and transponder used, the transponder will either transmit transponder identification information or transmit non-identification information stored in memory (e.g., information regarding the item that the transponder is adhered to) in response to the interrogation signal. Thereafter, the method 400 proceeds to step 410.

At step 410, the reader 302 receives and interprets information received from the transponder 310. The information received from the transponder 310 is stored in memory. Thereafter the method 400 proceeds to and ends at step 414.

In various embodiments, the reader 302 writes information to transponder(s) 310 that are designed to allow information to be written to them. In these embodiments, the method 400 proceeds towards optional step 412.

At step 412 the reader 302 transmits information towards the transponder 310 where it is stored in memory located within the transponder 310. Thereafter the method 400 proceeds to and ends at step 414.

Although method 400 is described and depicts as performing step 404 prior to performing step 406, it is appreciated that in various embodiments step 406 is initiated prior to the termination of step 404.

In yet other embodiments, the method 400 proceeds from step 404 towards step 406 via path 416. In these embodiments, step 406 is initiated even though the first information gathering subsystem at step 404 successfully gathered information.

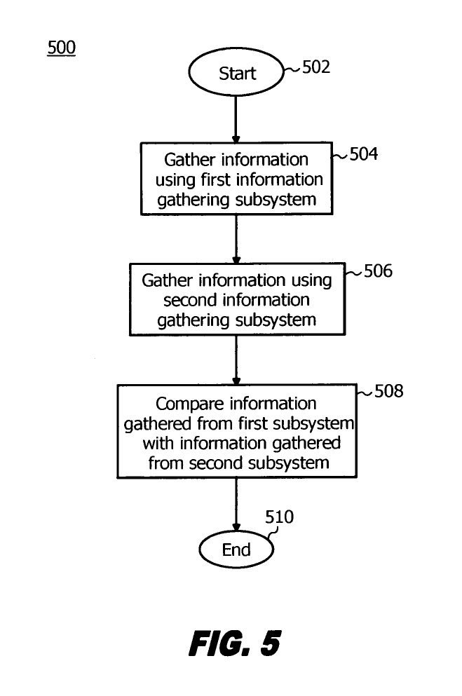

FIG. 5 depicts another flow diagram of an illustrative method 500 used in accordance with aspects of this disclosure. The information confirmation system (e.g., information confirmation system 100) is configured to include at least two independent information gathering subsystems.

For simplicity, FIG. 5 is described to include two information gathering subsystems (an RFID subsystem and an optical scanning code subsystem). However, this description is not intended in any way to limit the scope of the disclosure. It is appreciated that the information gathering system can include other types of information gathering subsystems. For example, the information gathering system can include at least an imaging subsystem and an RFID subsystem; or at least an imaging subsystem and an optical scanning subsystem. Once configured, the method 500 (or the other methods disclosed herein) can be implemented in the information confirmation system. The method 500 begins at step 502 and proceeds towards step 504.

At step 504, a first information gathering subsystem gathers information regarding an item (e.g., a package). For example, as an item moves along conveyor 102, a sensor detects the presence of the item (e.g., using the package in-tunnel indication subsystem 214) and optionally the weight of the item. While on the conveyor 102, information regarding the transportation of the item on the conveyor 102 can be recorded. For example, the height and width of the item (e.g., a package) can be gathered (e.g., using the package height/width profiling subsystem 212); and/or the velocity and length of the item (e.g. the package) can be gathered (e.g., using the package velocity/length measurement subsystem 210). When the item is within the range of the first information gathering subsystem the first information gathering subsystem acquires information. For example, when the first information gathering subsystem is an optical scanning subsystem (e.g., optical scanning subsystem 218) an attempt is made to scan the optical code (e.g., bar code). If the scan attempt is successful the information stored in the bar code is stored and interpreted. After the scan attempt, the method 500 proceeds towards step 506.

At step 506, a second information gathering subsystem attempts to gather information from the item. For example, when the second information gathering subsystem is an RFID subsystem (e.g., RFID subsystem 220) an RFID reader 302 communicates with transponder(s) 310 (as explained above). After the attempt to gather information from the transponder(s), the method 500 proceeds towards step 508.

At step 508 the method 500 compares the information gathered (if any) by the first information gathering subsystem with the information gathered (if any) from the second information gathering subsystem. Thereafter, the method proceeds towards and ends at step 510.

Although FIG. 5 depicts method 500 as attempting to gather information from one information gathering subsystem before attempting to gather information using another information gathering subsystem it is appreciated that attempts to gather information from the information gathering subsystems can be simultaneously.

In addition, when either of the information gathering subsystems fails to gather information at least one other information gathering subsystem acts as a backup for the user. For example, as explained above when the optical scanning subsystem is unable to scan optical code the information gathered from the RFID subsystem can be used to determine the information contained in the optical code.

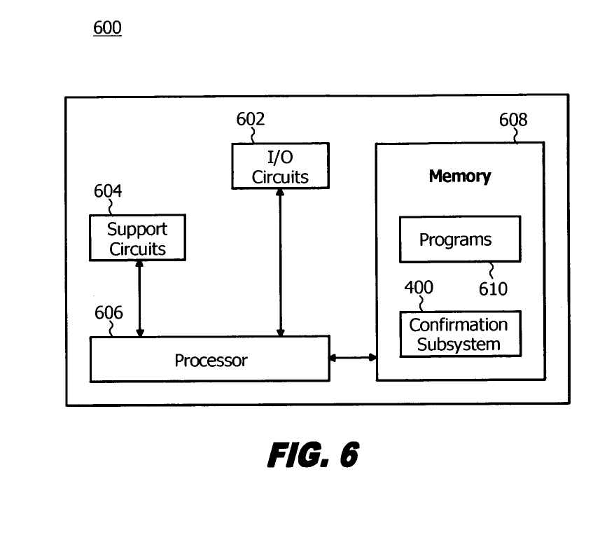

FIG. 6 depicts a high level block diagram of an embodiment of a controller 600, as part of electronic circuitry, suitable for use in providing a scan mode indicator (e.g., an audible signal) in accordance with a selected operation mode. The controller 600 of FIG. 6 comprises a processor 606 as well as a memory 608 for storing control programs 610 and the like. In addition, the memory 608 can also store the confirmation system 500 (as explained above in FIG. 5). Although FIG. 6 is depicted as including confirmation system 500 it is appreciated that controller 600 can include, in alternative embodiments, instructions for performing method 400. The processor 606 cooperates with conventional support circuitry 604 such as power supplies, clock circuits, cache memory and the like as well as circuits that assist in executing the software routines stored in the memory 608. As such, it is contemplated that some of the process steps discussed herein as software processes may be implemented within hardware, for example, as circuitry that cooperates with the processor 606 to perform various steps. The controller 600 also contains input-output circuitry 602 that forms an interface between the various functional elements communicating with the controller 600. For example, in various embodiments, the controller 600 also communicates with a data transmission subsystem for transmission of information to remote computer systems.

Although the controller 600 of FIG. 6 is depicted as a general-purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

Although various embodiments that incorporate the teachings of the present invention have been shown and described in detail herein, those skilled in the art can readily devise many other varied embodiments that still incorporate these teachings.

We claim:

1. A method comprising:
attempting to gather primary information using a first information gathering subsystem;
attempting to gather secondary information using a second information gathering subsystem; and
comparing said primary information when gathered by said first information gathering subsystem with said secondary information when gathered by said secondary information gathering subsystem.

2. The method of claim 1 wherein said first information gathering subsystem comprises one of an optical code scanning subsystem, a radio frequency identification (“RFID”) subsystem, a weighing subsystem, and an imaging subsystem; and
said second information gathering subsystem comprises one of said optical code scanning subsystem, said RFID subsystem, said weighing subsystem, and said imaging subsystem.

3. The method of claim 1 wherein said attempt to gather said secondary information occurs prior to a completion of said gathering of said primary information.

4. The method of claim 1 further comprising using said secondary information to determine said primary information.

5. The method of claim 1 wherein said attempt to gather said secondary information occurs during said attempt to gather said primary information.

6. The method of claim 2 further comprising:
attempting to gather tertiary information using a tertiary information gathering subsystem; and
comparing said primary information when gathered by said first information gathering subsystem with said secondary information when gathered by said secondary information gathering subsystem and said tertiary information when gathered by said tertiary information gathering subsystem.

7. The method of claim 6 wherein said tertiary information gathering subsystem is one of said optical code scanning subsystem, said RFID subsystem, said weighing subsystem, and said imaging subsystem.

8. The method of claim 6 wherein said attempt to gather said tertiary information occurs prior to a completion of at least one of said gathering of said primary information and said gathering of said secondary information.

9. The method of claim 6 wherein said attempt to gather said tertiary information occurs during at least one of said attempt to gather said primary information and said attempt to gather said secondary information.

10. The method of claim 6 further comprising using at least one of said secondary information and said tertiary information to determine said primary information.

11. A system comprising:
a conveyor;
a first information gathering subsystem strategically positioned with said conveyor to gather primary information from an item on said conveyor; and
a second information gathering subsystem strategically positioned with said conveyor to gather secondary information from said item on said conveyor.

12. The system of claim 11 wherein said first information gathering subsystem comprises an optical scanning subsystem adapted to scan optical code on said conveyor; and
said second information gathering subsystem comprises a radio frequency identification (“RFID”) subsystem.

13. The system of claim 12 wherein said RFID subsystem is adapted to interrogate at least one transponder when said optical scanning subsystem is unable to scan.

14. The system of claim 13 further comprising a processor adapted to determine from said at least one transponder said primary information.

15. The system of claim 11 wherein said first information gathering subsystem comprises one of a radio frequency identification (“RFID”) subsystem, an imaging subsystem, a weighing subsystem, and an optical scanning subsystem; and
said second information gathering subsystem comprises one of said RFID subsystem, said imaging subsystem, said weighing subsystem, and said optical scanning subsystem.

16. The system of claim 15 further comprising:
a third information gathering subsystem strategically positioned with said conveyor to gather tertiary information from said item on said conveyor, wherein said third information gathering subsystem comprises one of said RFID subsystem, said imaging subsystem, said weighing subsystem, and said optical scanning subsystem.

17. The system of claim 16 wherein an attempt to gather said tertiary information occurs prior to a completion of at least one of a gathering of said primary information and a gathering of said secondary information.

18. The system of claim 16 wherein an attempt to gather said tertiary information occurs during at least one of an attempt to gather said primary information and an attempt to gather said secondary information.

19. The system of claim 16 further comprising using at least one of said secondary information and said tertiary information to determine said primary information.

20. A computer-readable medium having stored thereon a plurality of instructions, the plurality of instructions including instructions which, when executed by a processor, cause the processor to perform the steps comprising:
attempting to gather primary information using a first information gathering subsystem;
attempting to gather secondary information using a second information gathering subsystem; and
comparing said primary information when gathered by said first information gathering subsystem with said secondary information when gathered by said secondary information gathering subsystem.

21. The computer-readable medium of claim 20 wherein said first information gathering subsystem comprises one of an optical code scanning subsystem, a radio frequency identification (“RFID”) subsystem, a weighing subsystem, and an imaging subsystem; and
said second information gathering subsystem comprises one of said optical code scanning subsystem, said RFID subsystem, said weighing subsystem, and said imaging subsystem.

22. The computer-readable medium of claim 20 wherein said attempt to gather said secondary information occurs prior to a completion of said gathering of said primary information.

23. The computer-readable medium of claim 20 further comprising using said secondary information to determine said primary information.

24. The computer-readable medium of claim 20 further comprising attempting to gather tertiary information using a third information gathering subsystem, wherein said third information gathering subsystem comprises one of said RFID subsystem, said imaging subsystem, said weighing subsystem, and said optical scanning subsystem.

25. The computer-readable medium of claim 24 further comprising using at least one of said secondary information and said tertiary information to determine said primary information.

26. The computer-readable medium of claim 24 wherein said attempt to gather said tertiary information occurs prior to a completion of at least one of said gathering of said primary information and said gathering of said secondary information.

27. The computer-readable medium of claim 24 wherein said attempt to gather said tertiary information occurs during at least one of said attempt to gather said primary information and said attempt to gather said secondary information.

28. Apparatus comprising:
a processor;
a first input adapted to receive primary information and coupled to said processor;
a second input adapted to receive secondary information and coupled to said processor; and
a first output adapted to transmit said primary and said secondary information and coupled to said processor.

29. The apparatus of claim 28 wherein said primary information comprises a first signal from one of an optical code scanner subsystem, a radio frequency identification (“RFID”) subsystem, a weighing subsystem, and an imaging subsystem; and
said secondary information comprises a second signal from one of said optical code scanner subsystem, said RFID subsystem, said weighing subsystem, and said imaging subsystem.

30. The apparatus of claim 29 further comprising a third input adapted to receive tertiary information and coupled to said processor wherein said tertiary information comprises a third signal from one of said optical code scanner subsystem, said RFID subsystem, said weighing subsystem, and an imaging subsystem.

31. A system comprising:
a first information gathering subsystem adapted to gather primary information comprising one of an optical code scanner subsystem, a radio frequency identification (“RFID”) subsystem, a weighing subsystem, and an imaging subsystem;
a control subsystem coupled to said first information gathering subsystem and adapted to communicate a signal comprising at least one of a failure to gather said primary information and said primary information;
a second information gathering subsystem coupled to said control subsystem and adapted to gather secondary information, wherein said second information gathering subsystem comprises one of said optical code scanner subsystem, said RFID subsystem, said weighing subsystem, and said imaging subsystem.

32. The system of claim 31 further comprising a third information gathering subsystem coupled to said control subsystem and adapted to gather tertiary information, wherein said third information gathering subsystem comprises one of said optical code scanner subsystem, said RFID subsystem, said weighing subsystem, and said imaging subsystem
